(19) United States
(12) Patent Application Publication
(10) Pub. No.: US 2019/0193560 A1
(43) Pub. Date: Jun. 27, 2019

(54) AUXILIARY POWER TAKE-OFF ASSEMBLY

(71) Applicant: ZF Friedrichshafen AG, Friedrichshafen (DE)

(72) Inventors: Michael TRÜBENBACH, Friedrichshafen (DE); Michael PREUß, Friedrichshafen (DE); Patrick KNIESS, Aulendorf (DE)

(21) Appl. No.: 16/315,260

(22) PCT Filed: Jun. 22, 2017
(86) PCT No.: PCT/EP2017/065399

§ 371 Date: Jan. 4, 2019

(30) Foreign Application Priority Data
Jul. 5, 2016 (DE) 10 2016 212 209.6

(51) Int. Cl. B60K 17/28; B60K 25/06

(52) U.S. Cl. CPC B60K 17/28; B60K 25/06; B60K 2025/065; B60Y 2400/404; B60Y 2400/408; B60Y 2400/405; B60Y 2400/424; B60Y 2400/406; B60Y 2400/421

(57) ABSTRACT

An auxiliary power take-off assembly (32) for a transmission (6) of a motor vehicle (2) having a torque converter (8). A driveshaft (30) is permanently connected to a drive motor (4), via the pump shaft (24) of the torque converter (8). In addition, the auxiliary power take-off assembly (32) has a transmission drive chain which includes at least a drive input element (34) and a drive output element (42) connected to an additional assembly (66) to be driven, and a shifting element (64, 68). The shifting element (64, 68) is functionally arranged between the driveshaft (30) and the drive input element (34) of the transmission chain for the optionally connecting the driveshaft (30) to the drive input element (34).

This application is a National Stage completion of PCT/EP2017/065399 filed Jun. 22, 2017, which claims priority from German patent application serial no. 10 2016 212 209.6 filed Jul. 5, 2016.

### FIELD OF THE INVENTION

The invention relates to an auxiliary power take-off assembly with a motor-dependent auxiliary power take-off for a vehicle transmission having a torque converter.

### BACKGROUND OF THE INVENTION

Vehicle transmissions in utility vehicles often have an auxiliary power take-off assembly by means of which additional attached assemblies of various types in the vehicle can be driven. This applies just as well to transmissions with a friction disk clutch as to transmissions fitted with a torque converter.

Auxiliary power take-offs are used particularly in buses, trucks, building machines, agricultural machines or special-purpose vehicles.

Auxiliary power take-offs are available in drive-dependent, clutch-dependent or motor-dependent designs. For example, drive-dependent auxiliary power take-offs supply the hydraulic system of dual-circuit steering systems with working pressure, whereby rolling vehicles still remain steerable when the primary system has failed due to an engine failure. Clutch-dependent auxiliary power take-offs are suitable for short-term or long-term operation during driving or at rest. Motor-dependent auxiliary power take-offs differ from clutch-dependent auxiliary power take-offs in that with motor-dependent auxiliary power take-offs there is a direct connection to the crankshaft of the drive motor of the vehicle, bypassing the vehicle clutch or the torque converter, so that such auxiliary power take-offs are permanently mechanically connected to the crankshaft of the drive motor. They are designed for high, constant power delivery in long-term operation and can be loaded with the maximum motor torque. They can be operated while the vehicle is driving or at rest, and can be engaged or disengaged under load. Typical fields of use are additional attached aggregates such as high-pressure pumps for fire engines, shuttle high-pressure flushing and suction vehicles, earth drilling equipment, concrete mixers and concrete pumps.

From DE 26 56 669 C2 a motor-dependent auxiliary power take-off on a vehicle transmission with a torque converter has become known, in which a drive engine of the vehicle is connected permanently by way of the pump shaft of the torque converter to a drive input shaft of an auxiliary power take-off assembly. The drive input shaft acts upon a transmission chain that consists of at least one drive input element in the form of a gearwheel and a drive output element, wherein the drive output element of the transmission chain is connected to an additional assembly which is to be driven. At the same time the drive input element of the transmission chain also drives a pressure medium pump of the transmission. The drive output element comprises a shifting element by which the additional assembly can be coupled to the auxiliary power take-off assembly.

In such an arrangement the whole of the transmission chain always runs together with the auxiliary power take-off assembly. The tooth engagements of the drive input element rotate constantly, since the shifting element of the auxiliary power take-off assembly is first arranged in the drive output element and thus only the downstream components can be decoupled. Accordingly, even at low loads there is always some rolling loss and in particular a lot of noise from the gear teeth. In addition the shifting clutch along with its associated actuating equipment take up a lot of space in the drive output element and make the auxiliary power take-off assembly a large and heavy attachment.

### SUMMARY OF THE INVENTION

The purpose of the present invention is to improve an auxiliary power take-off assembly and in particular to have a positive effect on noise emission and the fitting space required, and also to reduce losses.

This objective is achieved by an auxiliary power take-off assembly having the characteristics specified in the independent claims. Its design features are the object of subordinate claims.

In a vehicle having a transmission with a torque converter, an auxiliary power take-off assembly is provided. The pump shaft of the torque converter is connected permanently to a drive motor of the vehicle and, for its part, is in torque-transmitting connection with a drive input shaft of the auxiliary power take-off assembly. The auxiliary power take-off assembly comprises a transmission chain that enables torque to be transmitted between the driveshaft and an additional assembly to be driven. The said additional assembly can be any of the components described earlier in the surroundings of the utility vehicle. The transmission chain consists at least of a drive input element designed to take up torque from the driveshaft, and a drive output element designed to deliver torque to the additional assembly. In the auxiliary power take-off assembly a shifting element is provided, which according to the invention is functionally arranged between driveshaft and the drive input element of the transmission chain and serves to enable optional connection of the driveshaft to the drive input element. This makes it possible for the auxiliary power take-off assembly already directly behind the driveshaft connected to the pump shaft of the torque converter, to be completely decoupled from the rest of the transmission chain and the additional assembly so that when not needed those elements do not have to be entrained into rotation and therefore do not produce any losses and any noise. This increases the efficiency of the auxiliary power take-off assembly, which can also be made more compact due to the omission of the shifting clutch in the drive output element.

Advantageously, the drive input element in the transmission chain and the driveshaft have the same rotational axis, which is the case when the rotational axes of the torque converter and the transmission as a whole coincide. The shifting element then also has the same rotational axis. If the shifting element is arranged between the driveshaft and the drive input element, then without any negative effect on the fitting space available there it can have a diameter large enough to ensure a large effective surface area for torque transmission or for the production of friction.

In an advantageous embodiment of the invention, as the drive input element of the transmission chain a gearwheel of a gearwheel chain consisting of a mutually engaging sequence of gearwheels is provided. In auxiliary power take-off assemblies gearwheels form a tried and tested way to transmit torque, which can also be used if necessary to adapt the rotational direction of the drive output element and thus of the additional assembly.

An alternative way to transmit torque to the additional assembly is provided by a wrap-around drive, for example in the form of a metallic link chain or an elastic toothed belt or drive belt. In this case it is advantageous to provide a wheel of the wrap-around drive as the drive input element, which depending on the application carries external teeth or a corresponding groove for a V-belt.

Preferably, the shifting element is actuated pneumatically, hydraulically, by an electric motor or electromagnetically. The manner of actuation can be adapted to the respective circumstances of the vehicle. If the vehicle is a large utility vehicle whose brakes are actuated pneumatically, then a supply of compressed air is already present in the vehicle. In such cases the transmission of the vehicle is often also actuated pneumatically and by means of appropriate supply lines compressed air can also be delivered to the area of the shifting element in the transmission. In vehicles with hydraulic transmission actuation, in particular hydraulically shifted automatic transmissions having a gearset structure that consists of a series of planetary gearsets, the clutches and brakes within the transmission are actuated by a hydraulic control system whose delivery lines are inside or even outside the transmission and carry hydraulic fluid from the control unit to the said clutches and brakes. The lines are provided within the transmission both in the fixed transmission housing walls and also in rotating components such as the transmission shafts. Thus it can be advantageous in the case of hydraulic actuation to supply the hydraulic fluid through the driveshaft to the shifting element. For this, an appropriate seal on the driveshaft must be provided, which however, in such transmissions, is an often present measure since in numerous applications hydraulic fluid is conveyed by rotating shafts. The shifting element can be provided sitting directly on the driveshaft. In an advantageous design, for the hydraulic actuation the shifting element can be connected hydraulically to the control unit of the transmission. In that way an additional control unit for actuating the auxiliary power take-off assembly can be omitted and the shifting element is actuated directly from the transmission control system. Functional dependencies of the auxiliary power take-off control on the transmission controls can be adjusted to one another simply and quickly in the same control system. If necessary it is also possible to use components already present in the standard transmission control system, such as valves etc., conjointly for actuating the shifting element of the auxiliary power take-off assembly. Any pressure lines present in the transmission housing can if necessary also be used in the same way.

In the case of electromagnetic or electric motor actuation of the shifting element, the electric connection leads are laid out in the transmission housing or can be fixed on the inner or even the outer surface of the transmission housing between the shifting element and the associated control unit, so that the control unit can in this case too be incorporated in an electric part of a hydraulic control unit. Electric control can be realized regardless of the type of vehicle, since even in smaller utility vehicles there is bound to be an electric supply system. Electric motor and electromagnetic shifting elements are generally known to those with knowledge of transmissions. When electrical energy is supplied, a mechanical connection is formed between components that would rotate independently of one another in the absence of energy input. By virtue of the mechanical connection torque can be transmitted from the driveshaft to the drive input element in the auxiliary power take-off assembly.

Embodiments of the shifting element can advantageously provide that the shifting element is in the form of a claw shifting element, a cone synchronizer or a frictional shifting element. Claw shifting elements are preferably used for shifts at rest, since otherwise it is necessary for the parts of the claw shifting element which are to be joined to rotate at the same speed, and this must be brought about or established. With cone synchronizers the rotational speed equalization can be produced by means of the conical friction surfaces. When rotational speed equalization has been achieved, clutch gearing on the conical synchronizer can engage and transmit the torque. Like a frictional shifting element, a cone synchronizer can be engaged while the vehicle is driving. In a frictional shifting element a plurality of friction disks are provided, which in the non-actuated condition of the frictional shifting element can rotate relative to one another while in the actuated condition they are pressed against one another in order to transmit torque. As paired materials for friction disks adjacent to one another, steel/steel and lining/steel are suitable. Suitable linings for friction disks are generally known.

In an embodiment of a claw shifting element the shifting element is provided with claws on its end faces, which when actuated axially by suitable actuation means engage in one another axially. Such claw shifting elements are axially compact.

A further type of claw shifting element is advantageously designed in such manner that the claw shifting element is arranged in a shifting sleeve. In this case the individual claws again engage axially in one another but on the components involved the claws are arranged in the radial direction. As a rule such claw shifting elements are axially wider, but have greater stability.

### BRIEF DESCRIPTION OF THE DRAWINGS

The invention is described in greater detail with reference to drawings, which show:

FIG. 1: A schematic representation of a vehicle

FIG. 2: A transmission of a vehicle with an auxiliary power take-off assembly

FIG. 3: A first schematic representation of a shifting element

FIG. 4: A second schematic representation of a shifting element

### DETAILED DESCRIPTION OF THE PREFERRED EMBODIMENTS

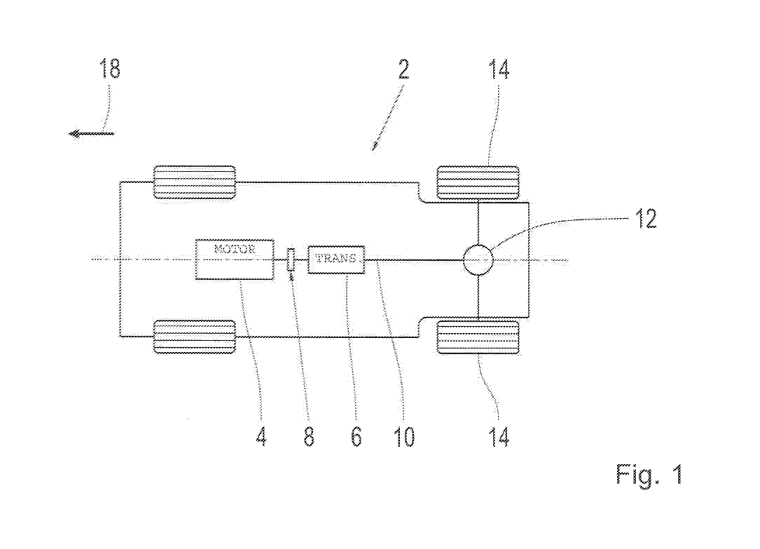

FIG. 1 shows a schematic vehicle representation of a motor vehicle 2 comprising a drive motor 4, a transmission 6 and a torque converter 8 arranged between the drive motor 4 and the transmission 6. The transmission 6 is connected by way of a drive output shaft 10 and a differential 12 to the two rear wheels 14.

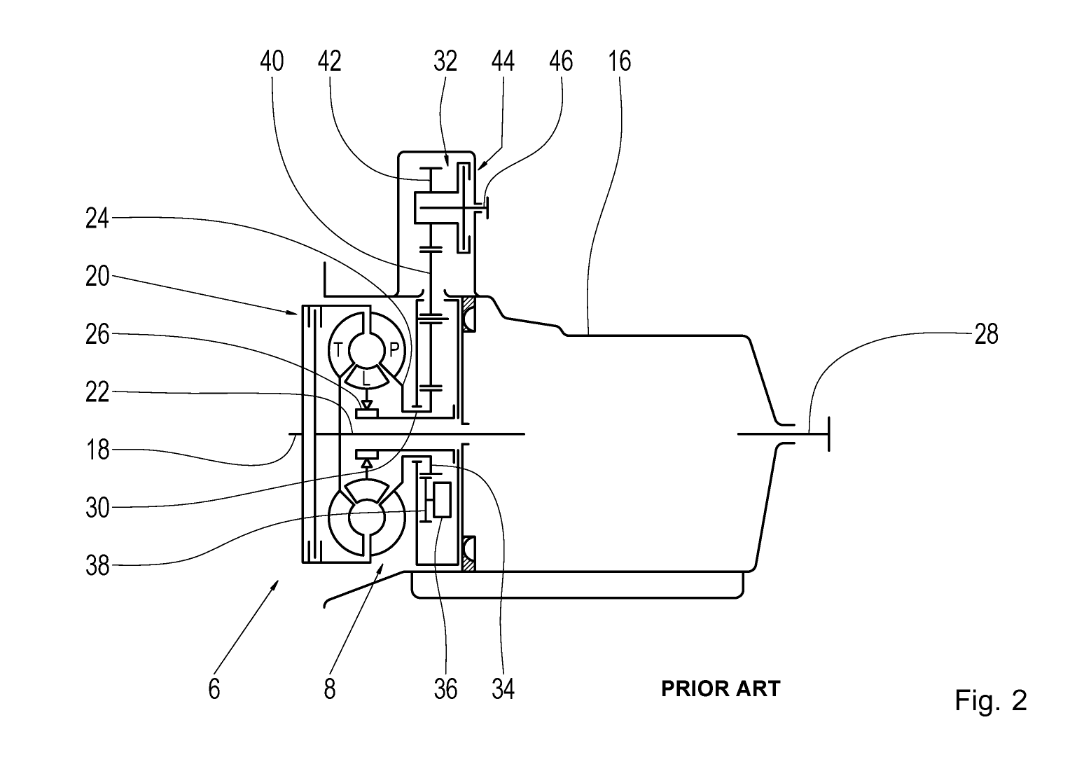

FIG. 2 shows an automatic transmission 6 with a torque converter 8, designed according to the prior art. In a transmission housing 16, a bridging clutch 20 is provided between the output shaft 18 of the drive motor 4 and the torque converter 8 and can connect the output shaft 18 to the transmission input shaft 22 in order to bridge across the torque converter 8. The output shaft 18 is connected via the pump wheel P of the torque converter 8 to the pump shaft 24. The turbine wheel T of the torque converter 8 is permanently connected to the transmission input shaft 22. The guide wheel L of the torque converter 8 is attached to the housing 16 by way of a freewheel 26. Projecting out of the transmission 6 is the output shaft 28, which is connected to the drive output shaft 10 (FIG. 1).

Connected to the pump shaft 24 is the drive input shaft 30 of the auxiliary power take-off assembly 32. In FIG. 2 the drive element 34 of the auxiliary power take-off assembly 32 is connected directly to the drive input shaft 30. The drive input element 34 serves on the one hand to drive a lubricant pump 36 via the gearwheel 38. On the other hand, via the drive input element 34 the intermediate wheel 40 of the auxiliary power take-off assembly 32 is turned, which in turn drives the drive output element 42 of the auxiliary power take-off assembly 32. Connected to the drive output element 42 is a shifting element 44 which optionally connects the drive output element 42 to the drive output shaft 46. In this arrangement the components always rotate along with the output shaft 18 of the drive motor 4 as far as the drive output element 42.

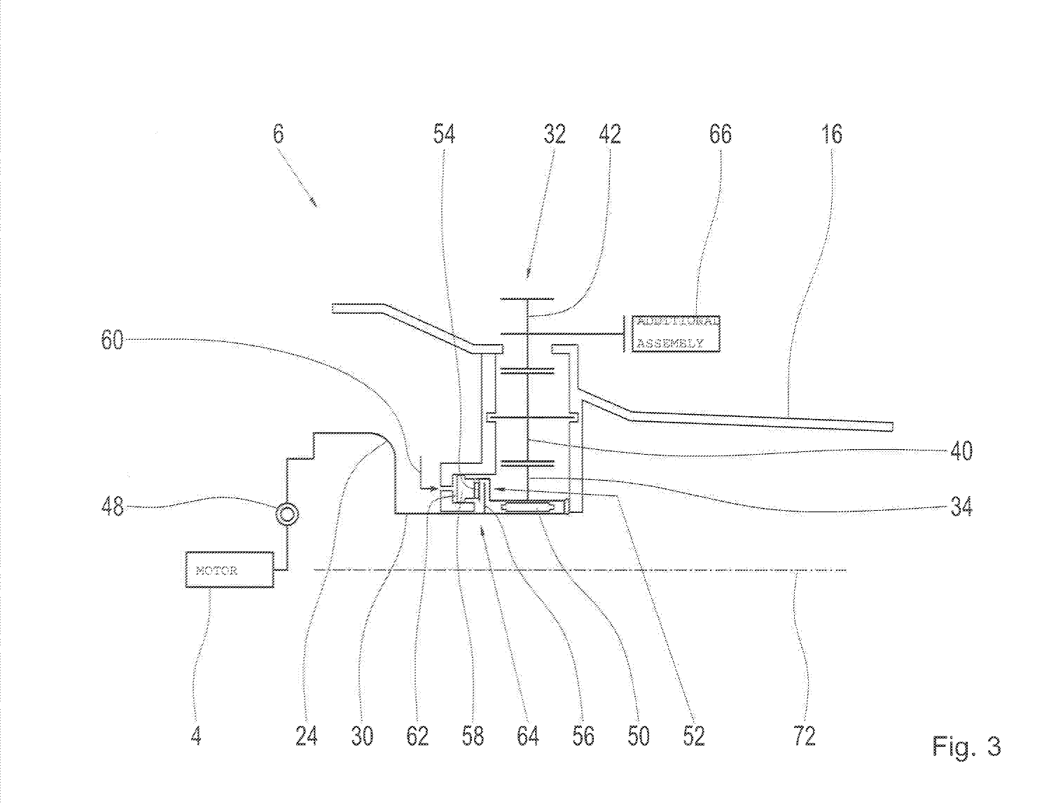

FIG. 3 shows a first embodiment of the invention, represented schematically. The same components as in FIG. 2 are given the same indexes. In the transmission housing 16 the pump shaft 24 is connected to the drive motor via a torsion damper 48. Connected to the pump shaft 24 is the driveshaft 30, on which the drive input element 34 of the auxiliary power take-off assembly 32 is mounted to rotate, for example in a needle bearing 50. The drive input element 34 has a friction disk carrier 52 on which at least one inner friction disk 54 is provided. The at least one friction disk 54 can be brought into torque-transmitting contact with at least one outer friction disk 56 on the driveshaft 30, in that the piston 58 presses the friction disk 54 against the friction disk 56. The rotational speed difference relative to the transmission housing 16 is compensated for by means of an axial bearing. The piston 58 is actuated by a hydraulically or pneumatically applied pressure, represented by the arrow 60, which pressure is built up in the piston chamber 62. The pressure is admitted from the inside of the transmission 6 through the transmission housing 16.

The essential elements of the shifting element 64 consist of the friction disk carrier 52, the friction disks 54 and 56 and the actuating piston 58. The intermediate wheel 40 in the auxiliary power take-off assembly 32 meshes with the drive input element 34, which wheel 40 in turn meshes with the drive output element 42. The additional assembly 66 to be driven is connected directly to the drive output element 42.

By means of the shifting element 64, the drive input element 34 can be decoupled from the driveshaft 30. Then, in the decoupled condition the components of the auxiliary power take-off assembly 32 and the additional assembly 66 are no longer driven and no longer rotate with the driveshaft 30. Noise and losses of the otherwise driven and rotating elements no longer occur.

The shifting element 64 and the driveshaft 30 rotate about the same rotational axis 72.

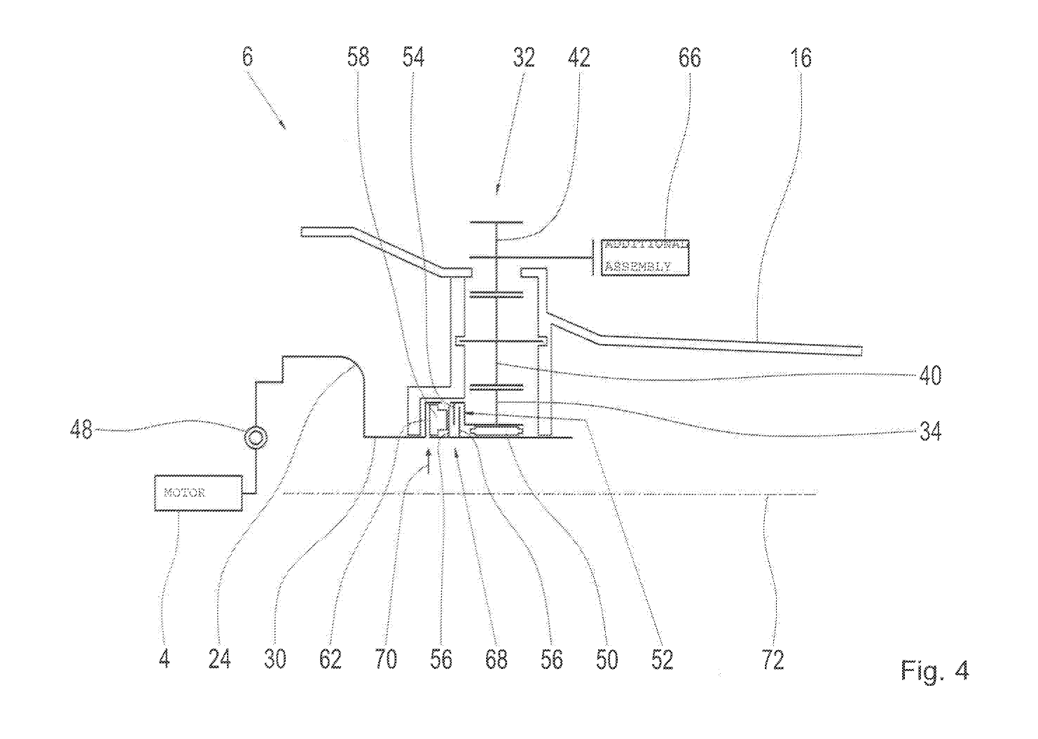

FIG. 4 shows a second embodiment of the invention, in which a modified shifting element 68 is provided. The other components correspond essentially to the components described in FIG. 3. In this case too a friction disk carrier 52 is built onto the drive input element 34, which carrier has at least one inner friction disk 54. Here, two outer friction disks 56 are provided, arranged on either side of the inner friction disk 54. When actuated the piston 58 presses the friction disks 54 and 56 together and thereby transmits torque between the driveshaft 30 and the drive input element 34. For the actuation of the piston 58 in this case pneumatic or hydraulic actuating media is delivered through the driveshaft 30 into the piston chamber 62, as indicated by the arrow 70.

### INDEXES

2 Motor vehicle
4 Drive motor
6 Transmission
8 Torque converter
10 Drive output shaft
12 Differential
14 Rear wheel
16 Transmission housing
18 Output shaft
20 Bridging clutch
22 Transmission input shaft
24 Pump shaft
26 Freewheel
28 Output shaft
30 Driveshaft
32 Auxiliary power take-off assembly
34 Drive input element
36 Lubricant pump
38 Gearwheel
40 Intermediate wheel
42 Drive output element
44 Shifting element
46 Drive output shaft
48 Torsion damper
50 Needle bearing
52 Friction disk carrier
54 Friction disk
56 Friction disk
58 Piston
60 Arrow
62 Piston chamber
64 Shifting element
66 Additional assembly
68 Shifting element
70 Arrow
72 Rotational axis
P Pump wheel
T Turbine wheel
L Guide wheel

1-10. (canceled)

11. An auxiliary power take-off assembly (32) for a transmission (6) of a motor vehicle (2) comprising:
a torque converter (8) having a driveshaft (30) permanently connected to a drive motor (4) via a pump shaft (24) of the torque converter (8), and
a transmission chain having at least one of a drive input element (34) and a drive output element (42),
the drive output element (42) being connected to an additional assembly (66) to be driven, and
a shifting element (64, 68), and the shifting element (64, 68) being functionally connected between the driveshaft (30) and the drive input element (34) of the transmission chain for an optional connection of the driveshaft (30) to the drive input element (34).

12. The auxiliary power take-off assembly (32) according to claim 11, wherein the drive input element (34) in the transmission chain and the driveshaft have a common rotational axis (72).

13. The auxiliary power take-off assembly (32) according to claim 11, wherein the drive input element (34) of the transmission chain is a gearwheel of a gearwheel chain.

14. The auxiliary power take-off assembly (32) according to claim 11, wherein the drive input element of the transmission chain is a wheel of a wrap-around drive.

15. The auxiliary power take-off assembly (32) according to claim 11, wherein the shifting element (64, 68) is actuated by one of a pneumatic, hydraulic, electric motor and electromagnetic means.

16. The auxiliary power take-off assembly (32) according to claim 15, wherein the shifting element (64, 68) is hydraulically actuated by hydraulic fluid which is delivered to the shifting element (68) through the driveshaft (30).

17. The auxiliary power take-off assembly (32) according to claim 15, wherein the shifting element (64, 68) is hydraulically actuated, and the shifting element (64, 68) is hydraulically connected to a control unit of the transmission (6) of the motor vehicle (2).

18. The auxiliary power take-off assembly (32) according to claim 11, wherein the shifting element (64, 68) is one of a claw shifting element, a cone synchronizer and a frictional shifting element (52, 54, 56).

19. The auxiliary power take-off assembly (32) according to claim 11, wherein the shifting element (64, 68) is a claw shifting element and the claw shifting element has claws on end faces thereof.

20. The auxiliary power take-off assembly (32) according to claim 18, wherein the shifting element (64, 68) is a claw shifting element and the claw shifting element is arranged in a shifting sleeve.

21. An auxiliary power take-off assembly for a transmission of a motor vehicle having a torque converter, the auxiliary power take-off assembly comprising:
a driveshaft being connected in a rotationally fixed manner, via a pump shaft of the torque converter, to a drive motor;
a transmission drive chain comprising a drive input element and a drive output element, and the drive output element being connected to an additional assembly to be driven; and
a shifting element being connectable between the driveshaft and the drive input element for transmitting drive from the driveshaft to the drive input element of the transmission drive chain to facilitate driving of the additional assembly to be driven.
